(19) United States
(12) Patent Application Publication
(10) Pub. No.: US 2020/0302320 A1
(43) Pub. Date: Sep. 24, 2020

(54) FUZZY INFERENCING FOR MANAGED RULES IN A COMPUTING SYSTEM

(71) Applicant: HEWLETT PACKARD ENTERPRISE DEVELOPMENT LP, Houston, TX (US)

(72) Inventors: Devon L. Dawson, Rocklin, CA (US); David L. Santos, Granite Bay, CA (US); John A. Powell, Granite Bay, CA (US)

(21) Appl. No.: 16/361,393

(22) Filed: Mar. 22, 2019

(51) Int. Cl. G06N 5/04; G06N 5/02; G06F 11/34

(52) U.S. Cl. CPC G06N 5/048; G06F 11/3476; G06N 5/02

(57) ABSTRACT

In one particular example, a fuzzy logic tool includes a computing system fuzzy logic tool, including: an interface through which, in operation, a user may enter a plurality of definitions for management inferencing rules, the management inferencing rules being expressed in fuzzy logic; a knowledge base containing fuzzy logic inferencing rules about computing system management; and inferencing engine that, in operation, applies the fuzzy logic inferencing rules to implement the fuzzy logic computing system management rules and manage the managed devices.

### BACKGROUND

Computing systems, such as computer networks, have now become sufficiently large that their effective management includes many automated tools and techniques. Many devices in a computing system are “managed”. They can be managed in several different ways. For instance, an administrator might actively manage a device by directly setting configuration parameters for the device. One common way of managing devices is to provide a device, or a group of devices, with a set of “rules” that govern their behavior.

So, an administrator might program a device with a rule that says something like:
If CPU>THRESHOLD generate ALERT

The device will then issue an alert if CPU usage exceeds some threshold value. Cumulatively, such rules can then govern the behavior of the computing system with only occasional human intervention.

### BRIEF DESCRIPTION OF THE DRAWINGS

Examples described herein may be understood by reference to the following description taken in conjunction with the accompanying drawings, in which like reference numerals identify like elements.

FIG. 1 depicts one particular example of a computing system operated and managed in accordance with the present disclosure.

FIG. 2 depicts selected portions of the hardware and software architecture of the administrative console in the computing system of FIG. 1.

FIG. 3 depicts selected portions of the hardware and software architecture of a switch in the computing system of FIG. 1.

FIG. 4 illustrates a method practiced in accordance with one or more examples disclosed herein.

FIG. 5 depicts one particular example of a computing system operated and managed in accordance with the present disclosure.

FIG. 6 depicts selected portions of a fuzzy logic tool as deployed in the computing system of FIG. 4.

FIG. 7 depicts one particular example of a computing system operated and managed in accordance with the present disclosure.

FIG. 8 depicts selected portions of a fuzzy logic tool as deployed in the computing system of FIG. 7.

FIG. 9 depicts one particular example of a computing system operated and managed in accordance with the present disclosure.

FIG. 10 depicts selected portions of a fuzzy logic tool as deployed in the computing system of FIG. 9.

FIG. 11 depicts one particular example of a computing system operated and managed in accordance with the present disclosure.

FIG. 12 depicts selected portions of a fuzzy logic tool as deployed in the computing system of FIG. 11.

FIG. 13 illustrates one particular example of stored information as may be used in the examples disclosed herein.

While examples described herein are susceptible to various modifications and alternative forms, the drawings illustrate specific examples herein described in detail by way of example. It should be understood, however, that the description herein of specific examples is not intended to be limiting to the particular forms disclosed, but on the contrary, the intention is to cover all modifications, equivalents, and alternatives falling within the spirit and scope of the examples described herein and the appended claims.

### DETAILED DESCRIPTION

Illustrative examples of the subject matter claimed below will now be disclosed. In the interest of clarity, not all features of an actual implementation are described in this specification. It may be appreciated that in the development of any such actual example, numerous implementation-specific decisions may be made to achieve the developers' specific goals, such as compliance with system-related and business-related constraints, which will vary from one implementation to another. Moreover, it may be appreciated that such a development effort, even if complex and time-consuming, would be a routine undertaking for those of ordinary skill in the art having the benefit of this disclosure.

Rules such as the one set forth above operate on precise quantitative values devoid of any context or quality. The administrator has decided that some numerical threshold represents an undesirable level of CPU usage and so has programmed the device to send an alert. However, context may determine whether some particular amount CPU usage is undesirable and, as context shifts, so might the assessment that the CPU usage is undesirable. Administrators realize this and adjust their quantitative values according to whether they wish for a conservative or a liberal posture relative to the particular behavior.

However, it is sometimes useful to program behavior regarding computing system operations in a qualitative fashion accounting for context. The approach disclosed herein provides nuance and flexibility to managing device behavior and, consequently, system-wide behaviors by using fuzzy logic inferencing in addition to, or in lieu of, the crisp rules currently in place. The fuzzy logic network management rules provide a more nuanced tool for managing the network (or device) and, hence, a more precise network operation. The invention also helps transfer the expertise from the network administrator to the system.

Fuzzy logic has been described as “many-valued logic” as opposed to “binary logic”. Binary logic systems return a single “truth value”, or an answer that is either matches the variable or does not. Rules including numerical values, for example, tend to be “binary”. This is sometimes also called “crisp”. Fuzzy logic, however, permits multiple matches to the logic and permits more contextually useful information. For example, it can indicate whether a certain operating parameter is “high”, “low”, or “acceptable”—that is, fuzzy logic can yield an answer that is actually a degree of truth rather than a crisp indication of truth.

The fuzzy logic system of the present disclosure includes input variables, output variables, membership functions defined over the variables' ranges, and fuzzy rules or propositions relating inputs to outputs through the membership functions. The aggregation of all rules is the basis for the fuzzy logic inferencing process. The rules are applied to the input variables using an inferencing engine in light of the membership function and results in the output variable.

Fuzzy logic or fuzzy inference can be used to enable and/or improve that ability of a human operator or computing system to monitor or measure a system parameter using rules that are defined in human readable semantics. In brief, fuzzy logic allows for fairly complex heuristics to be described in terms that are easier to understand (e.g., “send alert if PORTS_DOWN is HIGH” or “SECURITY_CONFORMANCE_MEASURE is HIGH if PASSWORD_LENGTH is LONG) with less domain knowledge than traditional discrete rules. The domain expertise (e.g., what is HIGH for a the number of ports down on a device) are encoded in the fuzzy “sets” or semantics (e.g., “LOW”, “HIGH”) and these sets can be adjusted at will by the rule writer with human understandable modifiers in the rule such as, “VERY”, “NOT VERY”, “SOMEWHAT”, “ABOUT”, “MORE_OR_LESS”, “ABOVE”, “BELOW”. Without the ability to use the fuzzy sets and modifiers many rules would need to be written to cover the same search in a way that gives a weighted measure of how well each searched for item matches the rule (e.g., “send alert if PORTS_DOWN is >=70 AND <80”, “send alert if PORTS_DOWN is >=80 AND <90”, “send alert if PORTS_DOWN is >=90 AND <100”) and each of those respective search results would be given the same resulting score, resulting in no distinction between a device 60 down ports and one with a 69.

The examples disclosed herein execute instructions to program and implement rules governing rules-based behavior in a computing system. Examples include fuzzy logic-based ruleinferencing on fuzzy logic-based rules to a metric from one or more managed devices to produce a variable fuzzy logic-based rule expression. The variable fuzzy logic-based rule expression can then be used as an input parameter to a fuzzy rule-based heuristic. The fuzzy rule-based heuristic can then provide information associated with the operation of the network device and/or the overall operation of the network. In some examples, the variable output from a fuzzy rule-based heuristic can be used as an input parameter to another fuzzy rule-based heuristic. In this manner, variable outputs from several fuzzy rule-based heuristics can be combined to provide information in response to fuzzy logic rules entered by the user.

In one particular example, a fuzzy logic tool includes a computing system fuzzy logic tool, including an interface through which, in operation, a user may enter a plurality of definitions for management inferencing rules, the management inferencing rules being expressed in fuzzy logic; a knowledge base containing fuzzy logic inferencing rules about computing system management; and inferencing engine that, in operation, applies the fuzzy logic inferencing rules to implement the fuzzy logic computing system management rules and manage the managed devices.

In another example, a computing system administrative console, includes a display; an input device; a processing resource; a bus system; and a memory. The memory communicates with the processing resource over the bus system and on which are encoded instructions that, when executed by the processing resource, cause the processing resource to: receive a plurality of definitions of computing system management inferencing rules through the display and entered using the input device, the computing system management inferencing rules being expressed in fuzzy logic; implement the fuzzy logic computing system management inferencing rules; and manage operation of a computing system using the fuzzy logic computing system management inferencing rules, including. Managing operation of the computing system further includes gathering operational information about the operation of the computing system; and inferencing on the gathered operation information using a knowledge base as defined by the fuzzy logic computing system management inferencing rules to analyze the operation of the computing system.

In a further example, a method for use in managing a computing system includes receiving a plurality of definitions of management inferencing rules directed to managing a plurality of managed devices, the management inferencing rules being expressed in fuzzy logic; implementing the fuzzy logic management inferencing rules; and managing operation of a computing system using the fuzzy logic management inferencing rule. Managing operation of the computing system further includes gathering operational information about the managed devices pertinent to the fuzzy logic management inferencing rules; and inferencing on the gathered operation information using a knowledge base as defined by the fuzzy logic management inferencing rules to manage the operation of the computing system.

In still another example, a non-transitory computer-readable medium encoded with instructions that, when executed by a processing resource, cause the processing resource to receive a plurality of definitions of management inferencing rules directed to managing a plurality of managed devices, the management inferencing rules being expressed in fuzzy logic; implement the fuzzy logic management inferencing rules; and manage operation of a computing system using the fuzzy logic management inferencing rules. Managing operation of the computing system further includes: gathering operational information about the managed devices pertinent to the fuzzy logic management inferencing rules; and inferencing on the gathered operation information using a knowledge base as defined by the fuzzy logic management inferencing rules to manage the operation of the computing system.

In yet another example, a computing system includes a plurality of managed devices; and a computing system fuzzy logic tool. The fuzzy logic tool further includes an interface through which, in operation, a user may enter a plurality of definitions for management inferencing rules, the management inferencing rules being expressed in fuzzy logic; a knowledge base containing fuzzy logic inferencing rules about computing system management; and an inferencing engine that, in operation, applies the fuzzy logic inferencing rules to implement the fuzzy logic computing system management rules and manage the managed devices.

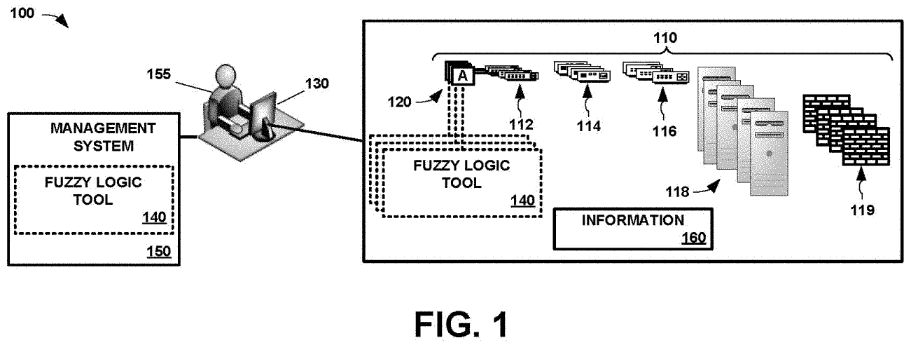

Turning now to the drawings, FIG. 1 depicts one particular example of a computing system 100 operated and managed in accordance with the present disclosure. The computing system 100 may be a network, but the subject matter claimed below is not so limited. The computing system 100 includes, in this particular example, a plurality of managed devices 110, an administrative console 130, one or more fuzzy logic tools 140, and operational information 160. Some examples will also include a management system (“MS”) 150 residing on the administrative console 130. Those in the art having the benefit of this disclosure will appreciate that many implementation specific details have been omitted for the sake of clarity and so as not to obscure that which is claimed below.

Although the example of FIG. 1 includes the management system 150, other examples may omit it. For example, some examples may forego the management system but use some other kind tool that performs the functionality discussed herein by which managed devices 110 can be implemented. Accordingly, whether any given example has a discrete component that may be called a “management system” or a “fuzzy logic tool” is not material so long as the functionality described herein is somehow implemented.

The managed devices 110 may include devices such as switches 112, bridges 114, routers 116, servers 118, and fireballs 119. However, this list is representative only and is neither exhaustive nor limiting. The managed devices 110 may include any device that is managed in the sense that the devices may be remotely programmed or configured, that data is generated that is indicative of its operation and, status, and that such data may be gathered for management purposes.

The management system 150 is shown as a single entity residing on the administrative console 130. Those in the art having the benefit of this disclosure will appreciate that this typically will not be the case. Management systems such as the management system 150 typically include many constituent parts distributed throughout the computing system 100. The management system 150 is depicted in FIG. 1 as a single entity residing on the administrative console 130 because in some examples it may be and as well as for ease of illustration.

As noted above, the computing system may include one or more fuzzy logic tools 140 depending on the implementation. In some examples, the fuzzy logic tool 140 may be integrated into and be a part of the management system 150. In other examples, the fuzzy logic tool 140 may reside on the managed devices 110. For instance, in the example of FIG. 1, each switch 112 includes a software implemented agent 120. The fuzzy logic tool 140 may be integrated into and form a part of each agent 120 for each switch 112. Each managed device 110 may be similarly equipped with an agent 120 including a fuzzy logic tool 140.

The information 160 may vary widely in nature and location. For, example, some of the information 160 may be logged data from the operation of the managed devices 110. The information may be archived data, such as archived plans that have already been implemented. A “plan” is a set of operating parameters used to configure a plurality of managed devices 110 in a large group. So, for instance, the switches 112 may all be reconfigured at one time and the configuration parameters will, collectively, define the “plan.” Such plans are routinely archived for future reference. However, not all of the information 160 will necessarily be stored. Some of the information 160 may be gathered in real time through the management system 150.

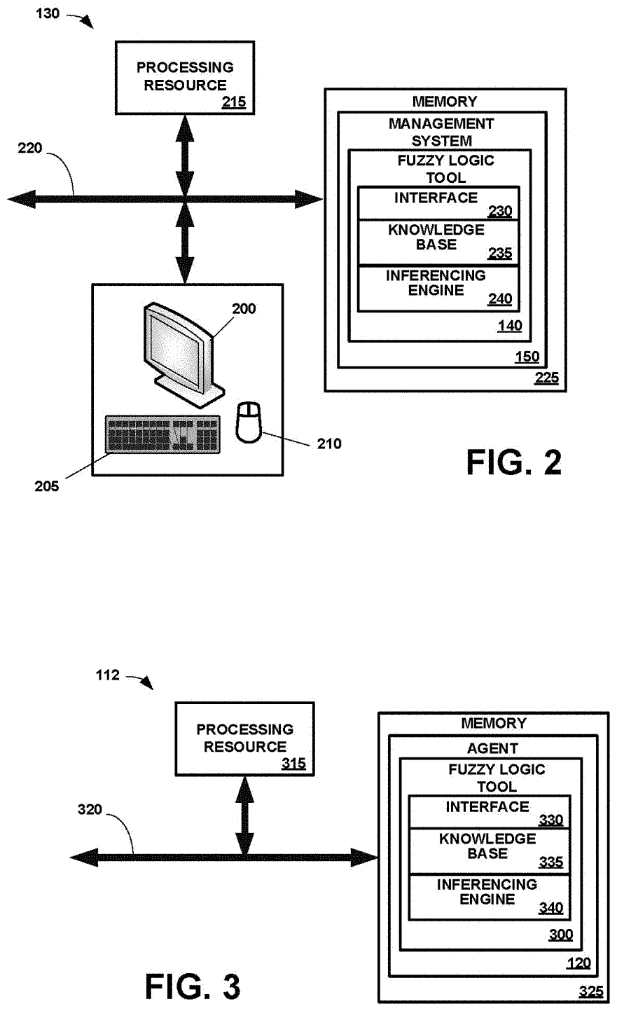

FIG. 2 depicts selected portions of the hardware and software architectures of the administrative console 130 in the computing system 100 of FIG. 1 in one particular example. In this example, the fuzzy logic tool 140 is a part of the management system 150 residing on the administrative console 130. The administrative console 130 includes, a display 200, an input device, such as the keyboard 205 and the mouse 210, a processing resource 215, a bus system 220, and a memory 225. Instructions, including the fuzzy logic tool 140, are encoded on the memory. The processing resource 215 communicates with the memory 225, and vice versa, over the bus system 220 to execute the instructions and, among other things, implement the functionality of the fuzzy logic tool 140.

The fuzzy logic tool 140 in this particular example includes an interface 230, a knowledge base 235, and an inferencing engine 240. The interface 230 may be, for example, a graphical user interface (“GUI”) or a command line interface (“CLI”) depending upon the implementation. In operation, a user, such as the administrator 155 in FIG. 1, may enter a fuzzy logic rule for information pertaining to an operation of the computing system 100. The knowledge base 235 contains fuzzy logic rules (not separately shown) about computing system operation which reflect a knowledge and experience of system operations. The inferencing engine 240, in operation, applies the fuzzy logic rules of the knowledge base 235 to the information 160, shown in FIG. 1, responsive to the logic of the fuzzy logic rules and executes the consequences specified in the rule.

FIG. 3 depicts selected portions of the hardware and software architectures of the switch 112 in the computing system 100 of FIG. 1. In this particular example, the fuzzy logic tool 140 is a part of an agent 120 that resides on the switch 112. The switch 112 includes a processing resource 315, a bus system 320, and a memory 325. Instructions, including the fuzzy logic tool 140, are encoded on the memory 325. The processing resource 315 communicates with the memory 325, and vice versa, over the bus system 320 to execute the instructions and, among other things, implement the functionality of the fuzzy logic tool 140.

The fuzzy logic tool 140 in this particular example includes an interface 330, a knowledge base 335, and an inferencing engine 340. The interface 330 may be, for example, a graphical user interface (“GUI”) or a command line interface (“CLI”) depending upon the implementation. In operation, a user, such as the administrator 155 in FIG. 1, may enter a fuzzy logic rule pertaining to an operation of the computing system 100. The knowledge base 335 contains fuzzy logic rules (not separately shown) about computing system operation which reflect a knowledge and experience of system operations. The inferencing engine 340, in operation, applies the fuzzy logic rules of the knowledge base 335 to the information 160, shown in FIG. 1, responsive to the fuzzy logic rules and execute the consequences specified therein.

Although FIG. 3 illustrates the fuzzy logic tool 140 residing on a particular switch 112, in some examples all managed devices 110 might include an agent 120 of which a fuzzy logic tool 140 is a part. Similarly, there may be examples where the routers 116, for instance, host fuzzy logic tools 140 through agents 120 while switches 112 do not. The claimed subject matter below is not limited to a situs at any particular point in the computing system 100 or to any particular number of fuzzy logic tools 140.

The examples set forth herein permit an administrator or other user to define fuzzy logic rules that monitor or measure various system parameters. Examples of such rules might include:
SECURITY_CONFORMANCE is HIGH if ACL COUNT is HIGH
SWITCH_VALUE is VERY LOW if PORT_UTILIZATION is LOW
SWITCH_CRITICALITY IS HIGH if CPU is USUALLY VERY HIGH
HOST_TRUST_LEVEL is LOW if PINGS_FROM_HOST is SOMEWHAT HIGH AROUND MIDNIGHT
POST_TRUST_LEVEL is VERY_LOW if PORT_LOCATION is NEAR DORMATORY_4

Note that this list of fuzzy logic rules is neither exhaustive nor limiting, but rather is representative of the kinds of fuzzy logic rules that may be used in various embodiments.

These fuzzy logic rules include input variables, some of which are fuzzy logic modifiers. For instance, input variables such as “HIGH”, “VERY HIGH”, “LOW”, “VERY LOW”, “ABOUT”, “A_LOT”, and “VERY_MANY” are not crisp variables but rather are fuzzy variables. These fuzzy variables are defined by “membership functions” not shown. Consider the descriptor “TEMP”, or temperature. The descriptor “TEMP” will be associated with a membership function that defines whether a temperature quantification is “HIGH”, “VERY HIGH”, “LOW”, or “VERY LOW”. The membership functions may conveniently be included as a part of the fuzzy logic tool in each embodiment although this is not required. The inferencing engine 240 uses the membership sets to determine whether accessed information belongs to the “membership set” of the fuzzy variable.

More particularly, the fuzzy logic-based rules can be representative of a defined membership function, e.g., triangular, Gaussian, Bell, exponential, etc., against which an individual and/or group of measured metrics can be compared to provide a variable fuzzy rule-based expression. That is, the inferencing engines 240, 340 in FIG. 2 and FIG. 3 can execute to inference on a fuzzy logic-based rule by comparing measured metrics with the defined functions they represent. The inferencing engines 240, 340 can then execute to produce a variable fuzzy rule-based expression based on the comparison, e.g., based on a particular measured metric fit to different portions of the function. Examples of such fuzzy rule-based expressions include, but are not limited to, “low”, “normal”, “high”, robust”, “congested”, “good”, “bad”, “average”, “busy”, “nominal”, etc. Other variable fuzzy rule-based expressions are also possible.

Application of fuzzy logic-based rules may accommodate natural language rules to define a relationship between measured metrics and their range of operation according to various defined functions associated with those fuzzy logic-based rules. The variable fuzzy rule-based expressions then provide a more intuitive expression to a user for the assessment of such measured metrics among various managed device(s) 110. That is, the fuzzy logic-based rule defines conditions that lead to a particular expression of information associated with each managed device, group of devices and/or the network as a whole. In various embodiments, application of the fuzzy logic-based rules can involve: first, defining functions for the fuzzy logic-based rules; second, setting the range of operation for the fuzzy logic-based rules associated with a particular metric, e.g., a percentage of processor usage. Each range can result in a different fuzzy rule-based expression. That is, for example, percent of processor usage between X and Y produces a fuzzy rule-based expression of “low”, between Y and Z produces a fuzzy rule-based expression of “high”, etc.

The inference engines 240, 340 can be executed to inference on fuzzy logic-based rules to the individual measured metrics in the accessed information as the metrics reflect information about a certain feature or component of a particular managed device 110. It is also possible that fuzzy logic-based rules can be applied to the same and/or different measured metrics from various managed devices 110. In addition, each particular measure metric can have a unique associated fuzzy logic-based rule applied thereto. It is also possible that one associated fuzzy logic-based rule can be used for more than one of the individual metrics.

In the example of FIG. 1, the management system 150 is an application and the fuzzy logic tool 140 is integrated into the management system 150 so that it forms a constituent part thereof. However, the subject matter claimed below is not so limited. For instance, in some examples the management system 150 and the fuzzy logic tool 140 may be implemented in a single daemon. In other examples, the management system 150 and the fuzzy logic tool 140 may be separate daemons, the management system 150 being called through an interface input and the fuzzy logic tool 140 being called by the management system 150. Similarly, in other examples, the management system 150 and the fuzzy logic tool 140 may be one or separate services. If separate services, the management system 150 may call the fuzzy logic tool 140. The nature of the software in terms of whether it falls into one or more such categorizations and which categorizations those are is not material to the practice of the subject matter claimed below.

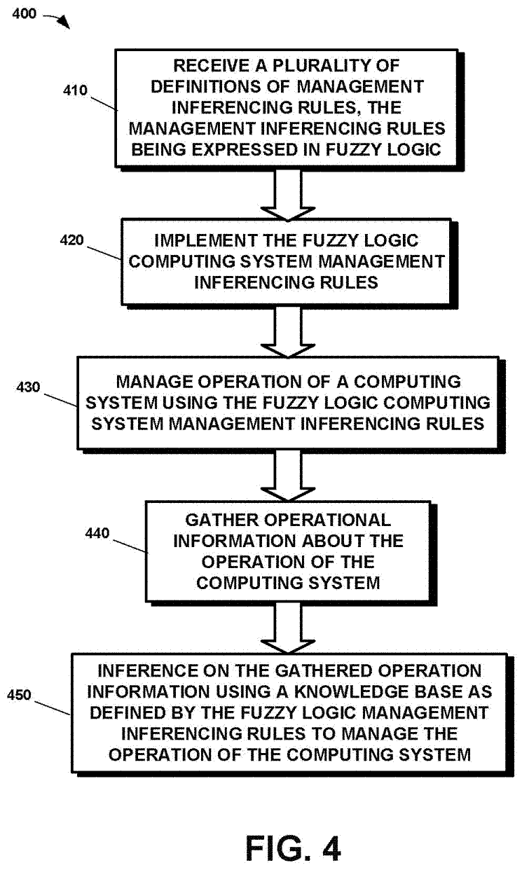

FIG. 4 illustrates a method 400 practiced in accordance with one or more examples disclosed herein. More particularly, the fuzzy logic tools 140 shown in FIG. 1-FIG. 3, in operation through execution by the processing resource 215 in FIG. 2 or the processing resource 340 in FIG. 3, perform the method 400. The method 400 begins by receiving (at 410) a plurality of definitions of management inferencing rules directed to managing a plurality of managed devices 110, the management inferencing rules being expressed in fuzzy logic. The method continues then by implementing (at 420) the fuzzy logic management inferencing rules. The method 400 next manages (at 430) operation of a computing system using the fuzzy logic management inferencing rules. The management (at 430) includes gathering (at 440) operational information about the managed devices 110 pertinent to the fuzzy logic management inferencing rules. The management (at 430) then inferences (at 450) on the gathered operation information using a knowledge base as defined by the fuzzy logic management inferencing rules to manage the operation of the computing system

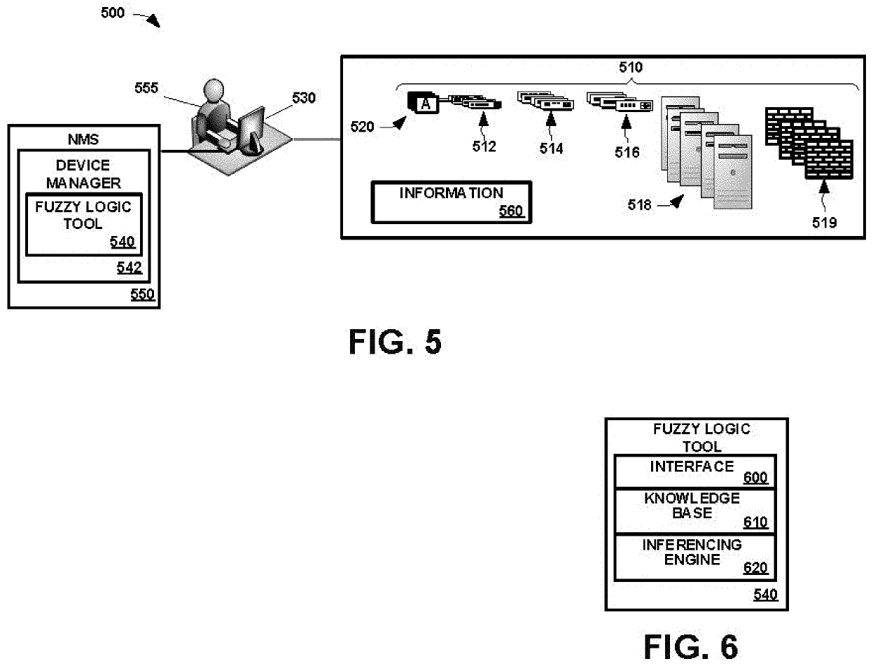

To further an understanding of that which is claimed below, another example of a computing system will now be discussed. FIG. 5 depicts one particular example of a computing system 500 operated and managed in accordance with the present disclosure. The computing system 500 is a network, which implies that it employs certain kinds of topologies, protocols, and architectures. The precise nature of those characteristics is not material to the practice of what is claimed below. For instance, the computing system 500 may implement either a client-server or a peer-to-peer connection without materially affecting the practice of what is claimed.

The computing, system 500 includes a plurality of managed devices 510, such as switches 512, bridges 514, routers 516, servers 518, firewalls 519, and a set of information 560. Some A network management system (“NMS”) 550 resides on an administrative console 530 used by a network administrator 555 to manage the resources of the computing system 500. The fuzzy logic tool 540 is, in this particular example, a part of the network management system 550 and, more specifically, a part of the device manager 542. As shown in FIG. 6, the fuzzy logic tool 540 includes an interface 600, a knowledge base 610, and an inferencing engine 620.

Returning to FIG. 5, the network management system 550 is a suite of software applications that are used to monitor, maintain, and control the software and hardware resources of the computing system 500. Areas of responsibility for the network management system may include security, performance, and reliability. Performance and reliability may include, for instance, discovery, monitoring and management of devices as well as analysis of network performance and providing alerts and notifications. The network management system 550 therefore may include one or more applications to implement these functionalities.

The network management system 550 in this particular example therefore includes a device manager 552 into which the fuzzy logic tool 540 may be integrated. For instance, one device manager offered under the mark ARUBA NETEDIT™ is commercially available from Hewlett Packard Enterprises. ARUBA NETEDIT™ may be used by a network administrator to orchestrate multiple switch configurations with capabilities such as searching, editing, validation, deployment, and auditing. Using ARUBA NETEDIT™, a network administrator may configure switches intelligently with validation for consistency and compliance, simultaneously view and edit multiple configurations, customize validation tests for corporate compliance and network design, and automate large-scale configuration deployment without programming. ARUBA NETEDIT™ thereby permits the automation of multi-device change workflows without programming and permits network administrators smoothly coordinate end-to-end service roll outs, automate rapid network-wide changes, and ensure policy conformance after network updates. This intelligent assistance and continuous validation helps assure that network-wide configurations are consistent and compliant.

Device managers such as ARUBA NETEDIT™ may be modified to integrate the fuzzy logic tool 540 to implement the presently claimed subject matter disclosed herein. For instance, ARUBA NETEDIT™ already includes an interface through which a network administrator interacts with the device manager, but it is limited to “crisp” language rules. The interface can be modified to accept fuzzy logic rules in addition to, or in lieu of, the crisp, language rules.

The information 560 may vary widely in nature and location. For example, some of the information 560 may be logged data from the operation of the managed devices 510. The information may be archived data, such as archived plans that have already been implemented. A “plan” is a set of operating parameters used to configure a plurality of managed devices 510 in a large group. So, for instance, the switches 512 may all be reconfigured at one time and the configuration, parameters will, collectively, define the “plan.” Such plans are routinely archived for future reference. However, not all of the information 560 will necessarily be stored. Some of the information 560 may be gathered in real time through the management system 550.

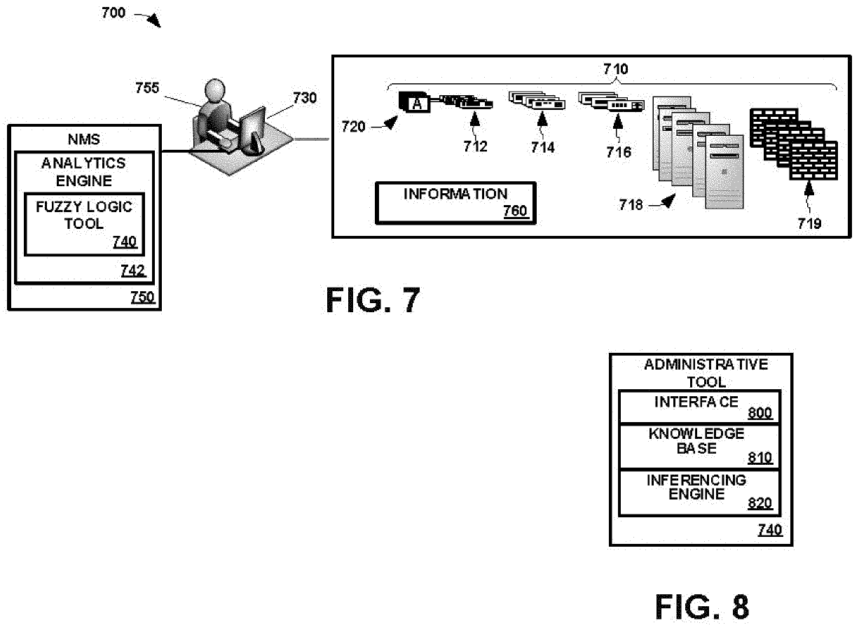

FIG. 7 depicts another particular example of a computing system 700 operated and managed in accordance with the present disclosure. The computing system 700 is also a network. The computing system 700 includes a plurality of managed devices 710, such as switches 712, bridges 714, routers 716, servers 718, firewalls 719, and a set of information 760. A network management system (“NMS”) 750 resides on an administrative console 730 used by a network administrator 755 to manage the resources of the computing system 700. The fuzzy logic tool 740 is, in this particular example, a part of the network management system 750. As shown in FIG. 5, the fuzzy logic tool 740 includes an interface 800, a knowledge base 810, and an inferencing engine 820.

Still referring to FIG. 7, the network management system 750 is a suite of software applications that are used to monitor, maintain, and control the software and hardware resources of the computing system 700. Areas of responsibility for the network management system may include security, performance, and reliability. Performance and reliability may include, for instance, discovery, monitoring and management of devices as well as analysis of network performance and providing alerts and notifications. The network management system 750 therefore may include one or more applications to implement these functionalities.

Many networks such as the computing system 700 include analytical capabilities. Different analytical capabilities may be implemented in different ways, but for present purposes they provide real-time data regarding the operations of managed devices. A managed device 710 may include, for example, an agent 720 that communicates with an analytics engine. The agent may periodically stream data to the analytic engine or report it periodically upon being polled by the analytics engine.

The network management system 750 in this particular example therefore includes an analytics engine 742 into which the fuzzy logic tool 740 may be integrated. For instance, one analytics engine is the Network Analytics Engine (“NAE”) in an analytics system offered under the mark ARUBA CX NOS™ is commercially available from Hewlett Packard Enterprises. The ARUBA CX NOS™ system includes switches with built-in monitoring capabilities. The ARUBA CX NOS™ provides default monitors but users may build their own using agents (programmed in PYTHON) that may then be uploaded into switch.

The NAE, and other analytics engines like it, may be modified to permit access to the agents and the current values of the system parameters they are monitoring, the historical time series data for those metrics, and the alerts that have been generated by the agent. A computing system employing such a modified analytics engine will be able to inference using fuzzy logic rules as discussed below. Systems using analytics engines such as ARUBA CX NOS™ may be modified to integrate the fuzzy logic tool 740 to implement the presently claimed subject matter disclosed herein. For instance, ARUBA CX NOS™ already includes an interface through which a network administrator interacts with the analytics engine, but it is limited to “crisp” language rules. The existing interface can be modified to accept fuzzy logic language to implement the interface 800 of the fuzzy logic tool 740. The analytics engine can then be modified to call the inferencing engine 820. Note that some examples may choose to implement the fuzzy logic rules in addition to the existing crisp rules.

The information 760 may vary widely in nature and location. For example, some of the information 760 may be logged data from the operation of the managed devices 710. The information may be archived data, such as archived plans that have already been implemented. A “plan” is a set of operating parameters used to configure a plurality of managed devices 710 in a large group. So, for instance, the switches 712 may all be reconfigured at one time and the configuration parameters will, collectively, define the “plan.” Such plans are routinely archived for future reference. However, not all of the information 760 will necessarily be stored. Some of the information 760 may be gathered in real time through the management system 750.

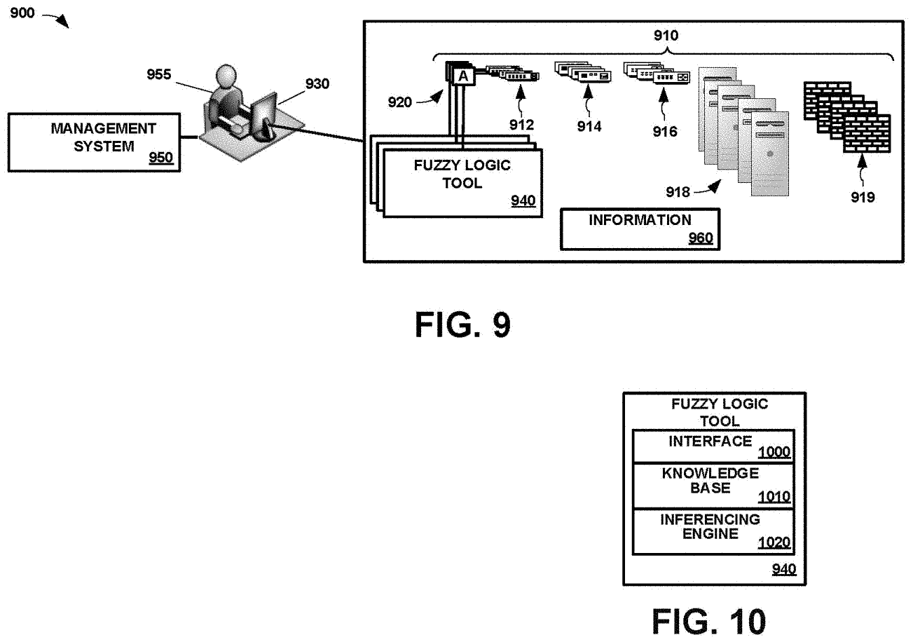

FIG. 9 depicts another particular example of a computing system 900 operated and managed in accordance with the present, disclosure. Unlike the computing systems of FIG. 5 and FIG. 7, the computing system 900 is not a network. The computing system 900 includes a plurality of managed devices 910, such as switches 912, bridges 914, routers 916, and servers 918, firewalls 919, and a set of information 960. A management system 950 resides on an administrative console 930 used by a network administrator 955 to manage the resources of the agents 920 for each managed device 910 that has an agent—i.e., the switches 912. As shown in FIG. 10, the fuzzy logic tool 940 includes an interface 1000, a knowledge base 1010, and an inferencing engine 1020.

Still referring to FIG. 9, the management system 950 is a suite of software applications that are used to monitor, maintain, and control the software and hardware resources of the computing system 900. Areas of responsibility for the network management system may include security, performance, and reliability. Performance and reliability may include, for instance, discovery, monitoring and management of devices as well as analysis of network performance and providing alerts and notifications. The management system 950 therefore may include one or more applications to implement these functionalities.

The information 960 may vary widely in nature and location. For example, some of the information 960 may be logged data from the operation of the managed devices 910. The information may be archived data, such as archived plans that have already been implemented. A “plan” is a set of operating parameters used to configure a plurality of managed devices 910 in a large group. So, for instance, the switches 912 may all be reconfigured at one time and the configuration parameters will, collectively, define the “plan.” Such plans are routinely archived for future reference. However, not all of the information 960 will necessarily be stored. Some of the information 960 may be gathered in real time through the management system 950.

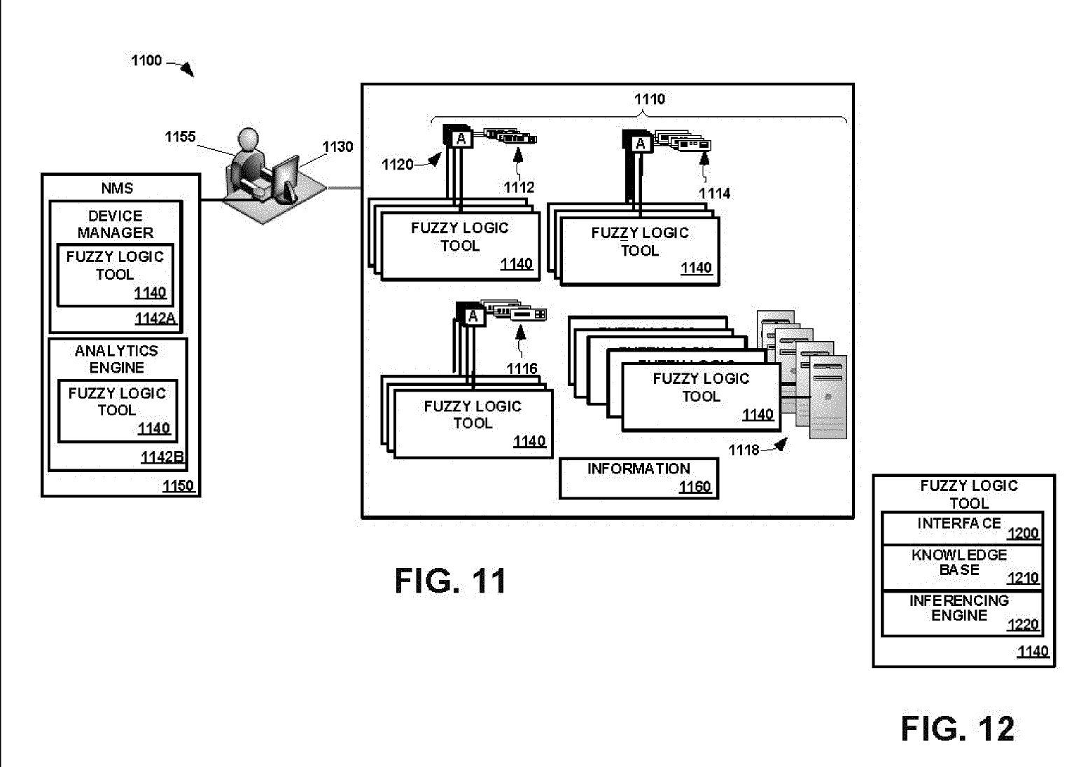

FIG. 11 depicts another particular example of a computing system 1100 operated and managed in accordance with the present disclosure. The computing system 1100 is also a network and combines the features of the computing system 500 in FIG. 5 and the computing system 700 in FIG. 7. The computing system 1100 includes a plurality of managed devices 1110, such as switches 1112, bridges 1114, routers 1116, and servers 1118. Each of the managed devices includes an agent 1120 of which a fuzzy logic tool 1140 is a constituent part. The computing system 1100 also includes a set of information 1160.

A network management system (“NMS”) 1150 resides on an administrative console 1130 used by a network administrator 1155 to manage the resources of the computing system 1100. The network management system 1150 includes a device manager 1142A and an analytics engine 1142B, each of which include a fuzzy logic tool 1150. As shown in FIG. 12, each fuzzy logic tool 1140 includes an interface 1200, a knowledge base 1210, and an inferencing engine 1220. The network management system 1150 is a suite of software applications that are used to monitor, maintain, and control the software and hardware resources of the computing system 1100. The network management system 1150, in this particular example, includes both a device manager 1142A and an analytics engine 1142B. Each of the switches 1112 includes an agent 1120 as discussed above.

The information 1160 may vary widely in nature and location. For example, some of the information 1160 may be logged data from the operation of the managed devices 1110. The information may be archived data, such as archived plans that have already been implemented. A “plan” is a set of operating parameters used to configure a plurality of managed devices 1110 in a large group. So, for instance, the switches 1112 may all be reconfigured at one time and the configuration parameters will, collectively, define the “plan.” Such plans are routinely archived for future reference. However, not all of the information 1160 will necessarily be stored. Some of the information 1160 may be gathered in real time through the management system 1150.

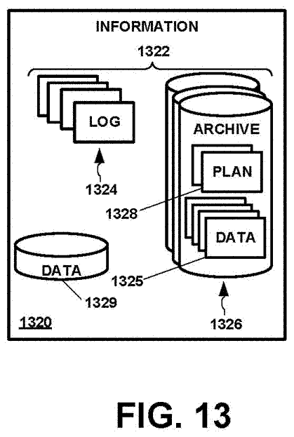

Each of the computing systems in the examples disclosed above includes a set of information. FIG. 13 illustrates one particular example of stored information as may be used in the examples disclosed above. Referring now collectively to FIG. 1 and FIG. 13, the computing system 100 gathers and sometimes stores all manner of information 120 that may be accessed by the management systems, device managers, analytic engines, etc. For example, many switches 112 and other managed devices include a capability by which operational data may be stored in one or more logs 1324. The contents of the logs 1324 may occasionally be archived as data 1325 in an archive 1326 for longer term storage. Similarly, as alluded to above, occasionally relatively large numbers of switches 112, shown in FIG. 1, may be reconfigured at the same time. The parameter changes by which such a reconfiguration is implemented are sometimes referred to as a “plan”. Plans 1328 are also generally archived. The information in the logs 1324 and the archives 1326 are accessible to the management systems, device managers, analytic engines, etc. Also, data is sometimes stored in databases 1329. For example, network management systems typically store data in local databases like the database 1329.

The examples provided herein are all set in the context of a distributed computing system, typically one that is networked. However, some examples, some of which are not illustrated herein, may be implemented in a stand-alone computing system instead of a distributed computing system. Accordingly, the examples illustrated herein are intended to provide a context for the description of the functions and operations of the present disclosure.

The figures set forth herein aid in depicting various architectures, functionalities, and operations of the examples disclosed herein. Throughout the description, many of the elements are defined, at least in part, as programs, programming, or program instructions. Each of these elements, portions thereof, or various combinations thereof may represent in whole or in part a module, segment, or portion of code that includes one or more executable instructions to implement any specified logical function(s). Each element or various combinations thereof may represent a circuit or a number of interconnected circuits to implement the specified logical function(s).

Some portions of the detailed descriptions herein are presented in terms of a software implemented process involving symbolic representations of operations on data bits within memory in a computing system or a computing device. These descriptions and representations are the means used by those in the art to most effectively convey the substance of their work to others skilled in the art. The process and operation require physical manipulations of physical quantities that will physically transform the particular machine or system on which the manipulations are performed or on which the results are stored. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical >quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “accessing”, “computing,” “calculating,” “determining,” “displaying,” and the like.

Furthermore, the execution of the software's functionality transforms the computing apparatus on which it is performed. For example, acquisition of data will physically alter the content of the storage, as will subsequent processing of that data. The physical alteration is a “physical transformation” in that it changes the physical state of the storage for the computing apparatus.

The examples disclosed herein may be realized in any non-transitory, tangible computer-readable media for use by or in connection with an instruction execution system, such as a computer/processor-based system, or an Application Specific Integrated Circuit (“ASIC”), or another system that can fetch or obtain the logic from computer-readable media and execute the instructions contained therein. Non-transitory, tangible computer-readable media may be any media that is capable of containing, storing, or maintaining programs and data for use by or in connection with the computing systems disclosed herein. Computer readable media may include any one of many physical media such as, for example, electronic, magnetic, optical, electromagnetic, or semiconductor media.

More specific examples of suitable computer-readable media include a portable magnetic computer diskette such as floppy diskettes or hard drives, a random access memory (“RAM”), a read-only memory (“ROM”), an erasable programmable read-only memory (“EPROM”), or a portable CD, DVD, or flash drive. Similarly, the transmission medium may be twisted wire pairs, coaxial cable, optical fiber, or some other suitable transmission medium known to the art. The technique is not limited by these aspects of any given implementation.

This concludes the detailed description. The particular examples disclosed above are illustrative only, as examples described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the, scope and spirit of the appended claims. Accordingly, the protection sought herein is as set forth in the claims below.

What is claimed is:

1. A method for managing a computing system, the method comprising:
receiving a plurality of definitions of fuzzy logic management rules directed to managing a plurality of managed devices, the fuzzy logic management rules being expressed in fuzzy logic;
implementing the fuzzy logic management rules; and
managing operation of a computing system using the fuzzy logic management rules, including:
gathering operational information about the managed devices pertinent to the fuzzy logic management rules; and
inferencing on the gathered operational information using a knowledge base as defined by the fuzzy logic management rules to manage the operation of the computing system.

2. The method of claim 1, wherein the, operational information is at least one of real-time operational information and stored operational information.

3. The method of claim 2, wherein the operational information includes the real-time operational information and the real-time operational information includes at least one of solicited operational information, and unsolicited operational information.

4. The method of claim 2, wherein the operational information includes the stored operational information and the stored operational information includes at least one of logged data and archived plans.

5. The method of claim 1, wherein the operational information is further pertinent to analytics of a computing system.

6. The method of claim 1, wherein implementing the fuzzy logic management rules includes implementing the fuzzy logic management rules on a managed device.

7. The method of claim 6, wherein implementing the fuzzy logic management rules includes implementing the fuzzy logic management rules in a management system.

8. The method of claim 1, wherein implementing the fuzzy logic management rules includes implementing the fuzzy logic management rules in a management system.

9. A non-transitory computer-readable medium encoded with instructions that, when executed by a processing resource, cause the processing resource to:
receive a plurality of definitions of fuzzy logic management rules directed to managing a plurality of managed devices, the fuzzy logic management rules being expressed in fuzzy logic;
implement the fuzzy logic management rules; and
manage operation of a computing system using the fuzzy logic management rules, including:
gathering operational information about the managed devices pertinent to the fuzzy logic management rules; and
inferencing on the gathered operation information using a knowledge base as defined by the fuzzy logic management rules to manage the operation of the computing system.

10. The non-transitory computer-readable medium of claim 9, wherein the operational information is at least one of real-time operational information and stored operational information.

11. The non-transitory computer-readable medium of claim 9, wherein the operational information is further pertinent to analytics of a computing system.

12. The non-transitory computer-readable medium of claim 9, wherein implementing the fuzzy logic management rules includes implementing the fuzzy logic management rules on a managed device.

13. The non-transitory computer-readable medium of claim 9, wherein implementing the fuzzy logic management rules includes implementing the fuzzy logic management rules in a management system.

14. A computing, system, comprising:
a plurality of managed devices; and
a computing system fuzzy logic tool, including:
an interface through which, in operation, a user may enter a plurality of definitions for fuzzy logic management rules, the fuzzy logic management rules being expressed in fuzzy logic;
a knowledge base containing fuzzy logic rules about computing system management; and
an inferencing engine that, in operation, applies the fuzzy logic rules to implement the computing system management fuzzy logic rules and manage the managed devices.

15. The computing system of claim 14, wherein the operational information is at least one of real-time operational information and, stored operational information.

16. The computing system of claim 14, wherein implementing the fuzzy logic management rules includes implementing the fuzzy logic management rules on a managed device.

17. The computing system of claim 16, further comprising a management system and wherein implementing the fuzzy logic management rules includes implementing the fuzzy logic management rules in the management system.

18. The computing system of claim 17, wherein the computing system is networked and the management system is a network management system.

19. The computing system of claim 17, wherein the management system includes at least one of a device manager and an analytics engine.

20. The computing system of claim 14, wherein the computing system fuzzy logic tool is an application, a daemon, or a service.
